(19) United States
(12) Patent Application Publication
(10) Pub. No.: US 2019/0179499 A1
(43) Pub. Date: Jun. 13, 2019

(54) SYSTEMS AND METHODS FOR PROVIDING A DIGITAL CONTENT READER AND COLLECTION DISPLAY APPLICATION IMPLEMENTING 3D GRAPHICAL USER INTERFACES AND INTERACTIONS

(71) Applicant: Qurika Inc., Los Angeles, CA (US)

(72) Inventor: Jacob George Matthew, Los Angeles, CA (US)

(21) Appl. No.: 16/165,350

(22) Filed: Oct. 19, 2018

Related U.S. Application Data
(60) Provisional application No. 62/575,362, filed on Oct. 20, 2017.

(51) Int. Cl. G06F 3/0483; G06F 3/0488; G06T 13/20

(52) U.S. Cl. CPC G06F 3/0483; G06T 13/20; G06F 3/04883

(57) ABSTRACT

Embodiments of the present invention are related to systems and methods for providing an eBook reader application implementing 3D graphical user interfaces and interactions. Specifically, embodiments of the present invention implement graphical user interfaces and interactions therefor, that provide an electronic representation that simulates a physical book on a computing device.

### CROSS REFERENCE TO RELATED APPLICATIONS

This application claims the benefit of U.S. Provisional Application No. 62/575,362 filed Oct. 20, 2017, the entire disclosure of which is hereby incorporated by reference in its entirety.

### FIELD OF THE INVENTION

Embodiments of the present invention are related to systems and methods for providing a digital content reader and collection display application implementing 3D graphical user interfaces and interactions. Specifically, embodiments of the present invention implement graphical user interfaces and interactions therefore, that provide an electronic representation that simulates a physical book on a computing device.

### BACKGROUND

Reading books and other written material on computing devices is a ubiquitous concept performed in many genres and mediums. However, all the implementations of the means for reading books and other written content are rudimentary and remove the format, feel and engagement a reader experiences when reading physical copies of the same or similar books or other written material.

For instance, most eBook reader applications simply apply a standard font size and type set to all materials provided on the application. While this provides a uniform approach, it also removes all stylistic and other physical properties associated with the work that may also limit the reader's ability to gauge certain aspects of the written material. For instance, reader applications currently lead to interface limitations, such as inability to provide graphical representation that may allow for users to gauge the size of a book (for example, size of book by total page count graphically displayed as a representation of a book with corresponding page count), and the inability, similarly, to show how many pages are remaining in a book, by way of a graphical representation of pages remaining vs. pages read.

Further, other than cover art, current reader applications do not provide any graphical representation of the books stored or available in a user's library of books available on a computing device.

Finally, while eBook reader applications allow for interactions with books that allow for simple transitions, such as simple page turns (back and forward), they do not provide for more in depth interactive capabilities that could only be provided when the written material is processed and generated into an interactive 3D design.

One issue with presenting a more complex 3D interactive design for digital content readers is that generating pagination and 3D graphical representations for digital content can be a computationally intensive operation. Performing these operations, or parts of these operations, at the time the 3D graphical representation is required may cause an undesired reduction in the performance of a system. For example, performing pagination while presenting an interactive 3D scene containing a physical book representation can slow a system's response to user input, making the interaction and experience a non-desirable one for the user.

Therefore there is a need in the art for a system and method for providing a reader application implementing 3D graphical user interfaces and interactions. These and other features and advantages of the present invention will be explained and will become obvious to one skilled in the art through the summary of the invention that follows.

### SUMMARY OF THE INVENTION

Accordingly, it is an object of the present invention to for providing a digital content reader and collection display application implementing 3d graphical user interfaces and interactions.

According to an embodiment of the present invention, a system for providing a reader application implementing 3D graphical user interfaces and interactions, comprises: a computer processor; a non-volatile computer-readable memory; and a graphical display element, wherein the non-volatile computer-readable memory is communicatively connected to said processor and graphical display element and is configured with computer instructions configured to: retrieve digital content from a data store; select pagination parameters; generate pagination for said digital content, based at least in part on said pagination parameters; select physical attributes; generate a 3D physical book representation of said digital content, based at least in part on said pagination and said physical attributes, wherein said 3D physical book representation of said digital content comprises a 3D scene of at least a portion of said digital content such that said 3D scene mimics the appearance of a physical book; and display said 3D physical book representation to said graphical display element.

According to an embodiment of the present invention, the non-volatile computer-readable memory is further configured to: convert said pagination to a second digital content item, wherein said digital second digital content item comprises a different format from said digital content retrieved from said data store, wherein said format of said second digital content item provides more efficient processing than a format of said digital content retrieved from said data store; and wherein said generation of said 3D physical book representation utilizes said second digital content item.

According to an embodiment of the present invention, the non-volatile computer-readable memory is further configured with computer instructions configured to: select second pagination parameters; analyze difference between pagination parameters and second pagination parameters; calculate estimated effect on page count based on said difference between pagination parameters and second pagination parameters; and generate modified page count based at least in part on said calculated estimated effect on page count for second pagination parameters.

According to an embodiment of the present invention, the non-volatile computer-readable memory is further configured with computer instructions configured to: calculate a plurality of 3D physical book representations, based at least in part on said pagination parameters; generate a second 3D scene, wherein said second 3D scene contains said plurality of 3D physical book representations; and display said second 3D scene on said display element.

According to an embodiment of the present invention, the non-volatile computer-readable memory is further configured with computer instructions configured to: receive user input; identify predefined gesture type from said user input; identify location of said user input; determine a group of pages of said physical book representation to turn based on said predefined gesture type and location; and generate a page turn animation based at least in part on said group of pages of said physical book representation.

According to an embodiment of the present invention, the non-volatile computer-readable memory is further configured with computer instructions configured to: receive user input; identify predefined gesture type from said user input; identify location of said user input; track changes in said user input; analyze said changes in said user input; and alter physical book representation, based on said changes in user input, such that a number of pages proportional to said changes in said user input are turned in said physical book representation.

According to an embodiment of the present invention, the non-volatile computer-readable memory is further configured with computer instructions configured to: receive user input; identify predefined gesture type from said user input; identify location of said user input, wherein said location is associated with a current page tab present on said physical book representation; track changes in said user input; analyze said changes in said user input; update location of said current page tab in said physical book representation based at least in part on said changes in said user input; determine page number for said updated location of said current page tab; and generate a page turn animation, based at least in part on said updated location of said current page tab.

According to an embodiment of the present invention, the non-volatile computer-readable memory is further configured with computer instructions configured to: receive user input; identify predefined gesture type from said user input; generate animation to open or close book based on said user input and a current state of said physical book representation.

According to an embodiment of the present invention, the non-volatile computer-readable memory is further configured with computer instructions configured to: receive user input; identify predefined gesture type from said user input; determine a page number of a page in said physical book representation associated with said user input; and generate animation and rendering of said page such that at least a portion of content on said page is visible for display on said display element.

According to an embodiment of the present invention, a method for providing a reader application implementing 3d graphical user interfaces and interactions, comprises the steps of: retrieving written material from a data store; retrieving metadata from said written material; determining page size for a page of said written material, based at least in part on said metadata; processing metadata associated with said written material to determine one or more appearance features; generating a 3D representation of said written material, wherein said 3D representation of said written material comprises at least 3D exterior imagery of said written material such that said 3D exterior imagery mimics the appearance of a physical book; and displaying said 3D representation of said written material on a graphical display element.

According to an embodiment of the present invention, the method further comprises the steps of: converting said pagination to a second digital content item, wherein said digital second digital content item comprises a different format from said digital content retrieved from said data store, wherein said format of said second digital content item provides more efficient processing than a format of said digital content retrieved from said data store; and wherein said generation of said 3D physical book representation utilizes said second digital content item.

According to an embodiment of the present invention, the method further comprises the steps of: selecting second pagination parameters; analyzing a difference between pagination parameters and second pagination parameters; calculating estimated effect on page count based on said difference between pagination parameters and second pagination parameters; and generating modified page count based at least in part on said calculated estimated effect on page count for second pagination parameters.

According to an embodiment of the present invention, the method further comprises the steps of: calculating a plurality of 3D physical book representations, based at least in part on said pagination parameters; generating a second 3D scene, wherein said second 3D scene contains said plurality of 3D physical book representations; and displaying said second 3D scene on said graphical display element.

According to an embodiment of the present invention, the method further comprises the steps of: receiving user input; identifying predefined gesture type from said user input; identifying location of said user input; determining a group of pages of said physical book representation to turn based on said predefined gesture type and location; and generating a page turn animation based at least in part on said group of pages of said physical book representation.

According to an embodiment of the present invention, the method further comprises the steps of: receiving user input; identifying predefined gesture type from said user input; identifying location of said user input; tracking changes in said user input; analyzing said changes in said user input; and altering the physical book representation, based on said changes in user input, such that a number of pages proportional to said changes in said user input are turned in said physical book representation.

According to an embodiment of the present invention, the method further comprises the steps of: receiving user input; identifying predefined gesture type from said user input; identifying location of said user input, wherein said location is associated with a current page tab present on said physical book representation; tracking changes in said user input; analyzing said changes in said user input; updating location of said current page tab in said physical book representation based at least in part on said changes in said user input; determining page number for said updated location of said current page tab; and generating a page turn animation, based at least in part on said updated location of said current page tab.

According to an embodiment of the present invention, the method further comprises the steps of: receiving user input; identifying predefined gesture type from said user input; generating animation to open or close book based on said user input and a current state of said physical book representation.

According to an embodiment of the present invention, the method further comprises the steps of: receiving user input; identifying predefined gesture type from said user input; determining a page number of a page in said physical book representation associated with said user input; and generating animation and rendering of said page such that at least a portion of content on said page is visible for display on said graphical display element.

### BRIEF DESCRIPTION OF THE DRAWINGS

FIG. 1A illustrates an exemplary process flow for providing an digital content application implementing 3d graphical user interfaces and interactions;

FIG. 1B illustrates an exemplary process flow for providing an digital content application implementing 3d graphical user interfaces and interactions;

FIG. 1C illustrates an exemplary process flow for providing an digital content application implementing 3d graphical user interfaces and interactions;

FIG. 1D illustrates an exemplary process flow for providing an digital content application implementing 3d graphical user interfaces and interactions;

FIG. 2 illustrates an exemplary process flow for providing an eBook reader application implementing 3d graphical user interfaces and interactions;

FIG. 3A illustrates an exemplary process flow for providing an eBook reader application implementing 3d graphical user interfaces and interactions;

FIG. 3B illustrates an exemplary process flow for providing an eBook reader application implementing 3d graphical user interfaces and interactions;

FIG. 3C illustrates an exemplary process flow for providing an eBook reader application implementing 3d graphical user interfaces and interactions;

FIG. 3D illustrates an exemplary process flow for providing an eBook reader application implementing 3d graphical user interfaces and interactions;

FIG. 3E illustrates an exemplary process flow for providing an eBook reader application implementing 3d graphical user interfaces and interactions;

FIG. 3F illustrates an exemplary process flow for providing an eBook reader application implementing 3d graphical user interfaces and interactions;

FIG. 4 illustrates a schematic overview of a computing device, in accordance with an embodiment of the present invention;

FIG. 5 illustrates a schematic overview of an embodiment of a system for providing an eBook reader application implementing 3d graphical user interfaces and interactions;

FIG. 6 illustrates a schematic overview of an embodiment of a system for providing an eBook reader application implementing 3d graphical user interfaces and interactions;

FIGS. 7A-7Q are illustrations of an interaction with a physical book representation, in accordance with an embodiment of the present invention;

FIGS. 8A-8G are illustrations of interactions with a physical book representation, in accordance with an embodiment of the present invention;

FIGS. 9A-9B are illustrations of interactions with a physical book representation, in accordance with an embodiment of the present invention;

FIGS. 10A-10C are illustrations of interactions with a physical book representation, in accordance with an embodiment of the present invention;

FIG. 11 is an illustration of a graphical user interface showing a collection display, in accordance with an embodiment of the present invention;

FIG. 12 is an illustration of graphical user interface showing a collection display, in accordance with an embodiment of the present invention;

FIG. 13 is an illustration of a network diagram for a cloud based portion of the system, in accordance with an embodiment of the present invention; and

FIG. 14 is an illustration of a network diagram for a cloud based portion of the system, in accordance with an embodiment of the present invention.

### DETAILED SPECIFICATION

Embodiments of the present invention are related to systems and methods for implementing 3D graphical user interfaces and interactions on a computing device with respect to digital content. Specifically, embodiments of the present invention implement graphical user interfaces and interactions therefore, that provide an electronic representation that simulates a physical book on a computing device.

For the purposes of this disclosure, the term digital content (or “content” or “content item”) may represent any electronically stored content, including, but not limited, textual content, graphical content, textual content that incorporate graphical content, multimedia content, video content, or any combination thereof. Examples of digital content may include, but are not limited to, epub files, other eBooks, PDF files, MICROSOFT WORD documents, text files, photo collections, web pages, websites, or any combination thereof. One of ordinary skill in the art may appreciate that there are numerous types of digital content that could be utilized with embodiments of the present invention, and embodiments of the present invention are contemplated for use with any type of digital content. The term digital content is being used to simplify the terminology used herein, and one of ordinary skill in the art may appreciate that where the word digital content is used, any of the aforementioned content types may be utilized in conjunction with or in place thereof.

Some embodiments of the system allow for viewing and interacting with a collection of such content as a whole. A non-exhaustive list of possible examples may include, but are not limited to, a set of ebooks or other digital content owned by a user, or eBooks offered for sale by a store, digital content files present in a storage device, or any combination thereof. Some embodiments may also allow for the viewing and interaction with the whole or parts of a physical book representation of individual digital content items, such as reading an eBook or a text file.

According to an embodiment of the present invention, the system utilizes 3D graphics, such as via computer systems configured to perform 3D graphics. Some terminology specific to this domain is therefore helpful for clarity and precision. In 3D graphics, a display device (such as a 2D screen, VR headset, holographic display, and the like) is set to a state such that it creates the impression in the viewer's mind of a 3D scene viewed from a particular position and orientation. Herein, when this is done for a particular 3D scene, we will say that the 3D scene is “presented” to the user. Note that a 3D scene may contain a mix of 2D and 3D elements, solely 2D elements, solely 3D elements, or any combination thereof.

In a preferred embodiment of the invention, digital content may be included as a 3D object in a 3D scene presented to the user. In particular, each content item in the scene is made to resemble, with some modifications, a physical book. Herein, such a visualization of the content may be referred to as a “physical book representation” of the content.

### Pagination

In a preferred embodiment of the present invention, an important step of generating a physical book representation of a content item is the “pagination” of the digital content. A physical book consists of pages, and in order to represent digital content as physical book representation, it also has to be laid out in the form of pages. This process is called pagination. Some digital content may already define a layout in terms of discrete pages (for example, PDF files), while some specify a layout that is continuous, or broken into parts based on criteria other than pages such as chapters (for example, epub files). For content that is already paginated, it may be necessary to redo the layout to change the page size, font, or other criteria. One of ordinary skill in the art may appreciate that there are numerous types of layout criteria that may need to be redone by the system, and embodiments of the present invention are contemplated for use with and processing of any type of layout criteria.

For content that is not paged, the system may breakup the layout into pages. In a preferred embodiment, the pagination of the content may depend on one or more layout criteria. Layout criteria may include, but is not limited to, desired page width, desired page height, choices for font style, choices for font size, or any combination thereof. The choices that affect the pagination are herein called the “pagination parameters”. In addition to the pagination parameters, the system may be configured to utilize other visual properties, such as page thickness, cover image, spine art, page color, wear and tear effect, to complete the physical book representation. In certain embodiments, the system may provide users the ability to select and/or adjust these additional pagination parameters in order to allow the user to be provided a physical book representation that is ideal for that user.

### Content Optimization

Generating a physical book representation of a content item can be a computationally intensive operation. Embodiments of the invention implement innovative ways in which to optimize this process. In preferred embodiments, the system may preprocess a content item and convert it to an optimized form from which a physical book representation may be generated more efficiently than from the original content item. This preprocessing is implemented as follows.

When the system determines that the impact on performance is acceptable (for example, when there is no user interaction for a certain period of time. Or before the system anticipates even more user interaction, such as when the user indicates that they want to read a content item), the system picks a content item to optimize and performs a pagination of the item for a particular set of pagination parameters. It uses the results of the pagination to generate an optimized form of the item from which a physical book representation may be recomputed faster than from the original item. For example, an item in the EPUB format may be paginated and the results used to generate a PDF file where the pages from the pagination are stored as the pages of the PDF. Since the PDF file is already in a paged format, generating a physical book representation from the PDF file can be more efficient that from the EPUB file. The PDF file is then the optimized form of the EPUB content item. Another example of an optimized form is simply a sequence of image files, one for each page of the pagination. One of ordinary skill in the art may appreciate that, in light of the above, there are numerous types of optimization and implementations (for example, concerning timing of pagination processing and format of the optimized form) that may be used with embodiments of the present invention, and embodiments of the present invention are contemplated for use with any such optimizations and implementations. In still further embodiments, pagination processing requests may be sent to a remote system (for example, remote data processing servers), where the pagination process may occur, with the remote system returning the processed digital content for use on the local device. In this embodiment, while networking resource utilization may increase, processor utilization may decrease. A tradeoff that may be acceptable in many cases. One of ordinary skill in the art may appreciate that embodiments of the present invention may utilize one or more of these methods, and embodiments may identify and select the appropriate means for processing pagination for the digital content (for example, local or remote), and all such embodiments are contemplated for use with the present invention.

When the system needs to generate the physical book representation for an item and if an optimized form of the item is available, the system may use the optimized form in place of the original item.

In still further embodiments, the pagination calculations and digital content conversions may also be performed and optionally stored on a different device, such as a remote server, and the results transferred over network. Offloading the calculation and storage to a remote device alleviates the possibility of performance degradation on the local device.

### Fast Page Count Estimation

When including a physical book representation for a particular set of pagination parameters in a 3D scene presented to the user, it may not always be necessary to have the complete results of the pagination in order to produce the representation. For example, if the physical book representation is in the closed state (for example, covers closed and no page content being displayed), then the layout of the individual pages is not needed since they are not seen by the user. However, even in such a state, it may be useful to have calculated the number of pages in the pagination since it affects the thickness of the book, which may be visible, even in the closed state.

Since computing the pagination may be computationally intensive, in some embodiments, when only the number of pages in the pagination for a particular choice of pagination parameters is required, and when one or more pagination results of possibly different pagination parameters are already calculated and available to the system, the system may avoid the full calculation of the pagination for the required parameters by approximating the number of pages using heuristics applied to the pagination results that are already available. For example, the number of pages for a font size twice that of a stored result may be approximated as being half that of the number of pages in the stored result. One of ordinary skill in the art may appreciate that there are numerous types of heuristics that could be utilize with embodiments of the present invention, and embodiments of the present invention are contemplated for use with any type of heuristics.

### Pagination Parameters for Content Collection Display

Unlike a real book, digital content may have many different paginations based on the pagination parameters. Therefore when including a physical book representation in a 3D scene, the system may be configured to make a choice about the pagination parameters to use. This may be particularly important when a 3D scene contains more than one physical book representation, since the viewer may use the relative thickness of the representations to estimate the relative size of the content, as can be done for real books in a library. If the representations use different pagination parameters however, then the relative thickness can be an inaccurate guide to the relative size of the content. For example, if two representations have the same thickness, the user may conclude that the number of words in both content items is approximately the same. But if it is the case that one representation used a font size much smaller than the other, this conclusion will likely be very inaccurate. In addition, the same content collection may be displayed at different times, using different pagination parameters each time, which may confuse the user since there no consistency in the thickness of the book.

To resolve this problem, in preferred embodiments, when a 3D scene containing more than one physical book representation is presented to the user, the pagination parameters used for all the physical book representations in the scene may be chosen so that they are either all the same or vary only such that they do not change the number of pages of the pagination significantly. In some embodiments, the pagination parameter can additionally depend on the properties of the device, for example the screen size. In other embodiments, the pagination parameters are independent of the specific device used to view the collection.

### Controlling Physical Book Represent Through User Input

According to an embodiment of the present invention, the system is configured to resend digital content as a physical book representation in a 3D scene. This representation introduces the challenge of providing the user with ways of interacting with the representation that competes in richness with that of a real book, while being constrained to the comparatively limited number of ways in which a user can provide input to a computer system. The present invention implements multiple innovative mechanisms by which a user can achieve this.

In some embodiments, the physical book representation of a content item may be set to a state of being turned to a particular page to resemble the way in which a real book can be turned to a particular page. Herein, such embodiments will be referred to as embodiments that allow reading of content. Some of the user input innovations encompass methods for processing user input to change the page that the representation is turned to.

### Animated Turn to Page

In embodiments that allow reading of content, the system may allow the user to initiate an animated turn of one or more pages of the representation. In such embodiments, when a pre-selected user input or combination of user inputs (such as a single tap, double tap, mouse click, and the like) is received, the current state of the physical book representation and other information about the content (such as chapters in an ebook) is analyzed along with the details of input received such as type, position, and duration, and a determination is made about whether the page the book is turned to should be changed, and if so which page to change it to.

In a preferred embodiment this determination may be done as follows. When the user input is a single tap on a touchscreen, or a single click of the mouse, at a location on approximately the left side of the page currently turned to, the determination is made to turn the page to the previous page, if any. Similarly, in a preferred embodiment, if the location of the tap is to the right side, then the determination is to turn to the next page, if any. Further, in a preferred embodiment, if the user input is a two finger tap, then instead of the next/previous page, a different result may occur, such as selection of the next/previous chapter, if any. Other results from a two finger tap may include, but are not limited to, next/previous search result, next/previous bookmark, or any combination thereof. One of ordinary skill in the art may appreciate that there are numerous input events that could be utilized to affect a single page or chapter turn event, and embodiments of the present invention are contemplated for use with any input event for effecting such actions.

In a preferred embodiment, once the determination is done to turn a page, the system enters a state of animation where the corresponding pages of the representation turn in a way that is similar to the turn of a page in a real book turn, but with some stylistic modifications.

Further, in preferred embodiments, the system continues to respond to further user inputs while an animation is in progress. This can lead to multiple page turn animations occurring simultaneously.

### Manual Page Turn

In embodiments that allow reading of content, the system may allow the user to control the turn of one or more pages of the representation through a continuous stream of user input. In such embodiments, when a pre-selected user input steam (such as a panning with one finger on a touch screen, click and drag with a mouse, or voice command) starts, or after a short delay after it starts, the system enters a state of determination where the current state of the physical book representation and other information about the content (such as chapters in an ebook) is analyzed along with the details of input received such as type, position, and direction, and a determination is made about which page to turn to if any. One of ordinary skill in the art may appreciate that the pre-selected user input stream could be comprised of any number and types of inputs, and embodiments of the present invention are contemplated for use with any appropriate user input stream.

According to an embodiment of the present invention, if the system determines an input event is received to turn to a particular page, then the group of pages between the current page and the target page are selected and the system enters a state where further inputs to the user input stream are analyzed and the selected group of pages are turned to reflect the input. When the stream of input ends, the system may enter a state of animation where the turn of the selected pages are completed along the same direction it was being turned or in the opposite direction.

For example, in preferred embodiments, when a one-finger-pan is received that starts in the direction of left to right, the determination is made to turn to the next page and the current page is selected for the manual turn. Further progress on the one-finger-pan is analyzed and the selected page is made to turn to reflect the movements of the finger. If the finger moves further along the right to left direction, the selected page is turned further from right to left to track the finger, and if the finger moves back to the right from the left, the selected page continues to track the finger by turning an appropriate amount to the right from the left.

### Current Page Tab

In embodiments which allow for reading of content, a visual component, herein called the “current page tab”, can be attached to the physical book representation to denote the page that the representation is turned to. In a preferred embodiment, the shape of the current page tab is a 2D rectangle with a size similar to that of UI buttons, and with the page number and total number of pages in the representation displayed in text on the tab. One of ordinary skill in the art may appreciate that the current page tab could be represented in any number of graphical elements, not just a 2D rectangle, and embodiments of the present invention are contemplated for use with current page tabs designed and displayed in any form.

In preferred embodiments the current page tab is positioned at the right edge of the page that the representation is currently turned to. In these preferred embodiments, the specific location of the tab on the right edge is determined as follows. When the physical book representation is to be turned to a specific page, the system calculates the percentage of the total number of pages in the representation the turned to page number is. The location of the tab is then calculated so that at 0%, the tab will be aligned to the top of the right edge of the current page, at 100% the tab will be aligned to the bottom of the right edge of the current page, and at intermediate percentages, the tab will be a corresponding distance between the top and bottom of the right edge. Once the location is determined, the tab is positioned according to the computed location in the 3D scene along with the physical book representation, and the 3D scene is presented to the user. When the physical book representation is to be updated by the system, the location of the tab is recalculated according to the above rules, and tab repositioned in the scene along with the updated physical book representation and the updated 3D scene is presented to the user. One of ordinary skill in the art may appreciate that this alignment could vary in alternative embodiments, and embodiments of the present invention are contemplated for use with any alignment.

The above calculations detail how the tab is positioned once the representation is turned to a specific page. Since some embodiments allow for the animation and manual control of page turns, the representation can be in an intermediate state where pages are in the process of turning and have not fully turned to a specific page. In such embodiments the current page tab may still be displayed for visual continuity and the position may be based either on the page number the representation is expected to be turned to after the animation or user input is complete, the last page number the representation was turned to, or some interpolated value in between. This ensures changes to the location of the tab are smooth.

In a preferred embodiment, the system is configured to respond to user input applied to the current page tab. In particular, in this preferred embodiment, the system is configured to allow the user to drag the tab using user inputs such as one-finger-pan or dragging with a mouse, or via voice command. The tab may be dragged along a fixed path, specifically a path defined by interpolating between the tab's position for each page number of the book. In addition, when a user input is received that causes the tab to be moved to a new position, the system may calculate the page number associated with that position and initiate an animation to turn the book to that page. One of ordinary skill in the art may appreciate that there are numerous types of inputs and pathing (fixed or not) that could be utilized, and embodiments of the present invention are contemplated for use with any type of input and pathing for these events.

Since dragging the tab from the its location corresponding to one page to that of another page may involve moving it through the locations corresponding to all the pages in between, this can result in many page turn animations started in quick succession and running simultaneously, which can be computationally intensive and confusing to the user. To avoid this problem, in certain embodiments, when the tab is being dragged, the system implements a throttling of the rate in which page turn animations are generated. Instead of unconditionally generating a page turn animation when the tab is dragged to a specific location, the system analyzes metrics, such as the time since the last page turn animation was generated, and/or the distance the tab has moved since the last page turn animation generated, and/or the number of pages to be turned, and may skip the page turn animation if certain conditions are met. In preferred embodiments the throttling is implemented so that page turn animations generated by dragging the current page tab are at least a fixed time interval apart.

### Shutting and Reopening the Book

Embodiments that allow for reading of content may allow, through user interaction functionality, the ability for the user to quickly transition from a first 3D scene, wherein the physical book representation is in an open representation, with the pages and content being displayed, to a second 3D scene in which the physical book representation is closed shut, with the exterior elements of the physical book representation being displayed. Embodiments of the present invention allow for the second 3D scene to be transitioned back again to the first 3D scene quickly via user interaction functionality. This allows the user, among other things, to quickly get an overview of the content item, such as via the cover page, thickness of the physical book representation of the content item, and more, even while in the process of reading the physical book representation of the content item and return quickly back to continue reading.

In preferred embodiments, this functionality is implemented in the following manner. When a 3D scene that contains a physical book representation, turned to a particular page, is presented to the user, the system monitors the user inputs to determine if a pinch-in gesture is received. When the system determines that a pinch-in gesture has started, it enters a state where the open/close state of the physical book representation is modified to reflect changes in the gesture. As the fingers get closer to each other, the book representation is modified to get closer and closer to a fully shut state in a way that resembles shutting a real book. When the gesture ends, the system may enter a state of animation where the representation continues to close until it has reached the fully closed state.

Further, when presenting a 3D scene of a physical book representation in a fully closed state, the system may store a page number the physical book representation was in before it was shut. A current page tab may also be positioned in the 3D scene to display data corresponding to this stored page number. The system may be configured to monitor user inputs to determine if a gesture (for example, pinch-out gesture) is received. In one example, when the system determines that a pinch-out gesture has started, the system may enter a state where the open/close state of the 3D scene of the physical book representation is modified to reflect changes in the gesture. For instance, as the fingers move further apart from each other, the book representation is modified to get closer and closer to a fully open state in a way that resembles opening a real book and where the page number the book is opened to is the stored page number. In this example, when the gesture ends, the system may enter a state of animation where the representation continues to open until it has reached the fully open state. While preferred embodiments of the present invention may utilize a pinch gesture for this feature, one of ordinary skill in the art may appreciate that there are numerous other types of gestures that could be utilized with this (and other) features incorporated with embodiments of the present invention, and embodiments of the present invention are contemplated for use with any type of gesture for this and any other feature.

Some embodiments of the system may allow for shutting and opening of the physical book representation entirely through animation and triggered by user input such as a double-tap instead of a continuous gesture like a pinch-in and pinch-out. One of ordinary skill in the art may appreciate that embodiments of the present invention could implement this through any number of gestures, each contemplated for use with embodiments of the present invention.

### Peeking Into a Page

In embodiments that allow for reading of content, user interaction functionality may be implemented that allows the user to view the contents of a page in the physical book representation without fully turning the physical book representation to that page. This process is herein called “peeking into a page”. In this method, a user interaction element, such as a button or user input gesture, may be made available to the user during or after peeking into the page which the user may use to turn the book to the peeked into page if the user chooses to. One of ordinary skill in the art may appreciate that the user interaction element could be implemented in numerous ways, and embodiments of the present invention are contemplated for use with any appropriate user interaction element.

In preferred embodiments, the peek into a page functionality is implemented as follows. The system may be configured so that when the user places a finger on an edge of a page, that page may be selected for peeking into, herein called a “peek target”. Once the peek target has been determined, the system modifies the 3D scene of the physical book representation so that some or all of the pages around and possibly including the peek target are partially turned in such a way that some or all parts of the content of the peek target page are visible. If the user moves the finger, a new peek target may be selected based on the new location of the finger and the representation updated accordingly. When the user removes the finger from screen, the representation may return back to the position it was before the peeking action. If not, an additional gesture or user control (such as a button) may be made available to the user to undo the peeking action. The turning of the pages to achieve the peeking functionality may or may not be performed through animations. In preferred embodiments, animations are used. While in this preferred embodiment, a finger touch on the edge of a page is used to engage the peek into a page functionality, other gestures may also be implemented on other embodiments of the system, and such gestures are contemplated for use with embodiments of the present invention.

In preferred embodiments, while peeking into a page, a button is displayed in the 3D scene which when clicked, turns the book to the peeked into page. The button may be displayed for a short time after the peeking is completed as well to give the user more time to decide if they want to turn to that page.

### Book Navigation Using Tabs

In embodiments which allow for reading of content, it is useful for the user to be presented with a list of positions into the content, and to be able to turn the representation to the page corresponding to that position. Examples of such use cases are: positions that correspond to search results for a particular search string provided by the user, bookmarks that the user has made previously, the start of chapters in an eBook, or any combination thereof. One of ordinary skill in the art may appreciate that there are numerous use cases, and embodiments of the present invention are contemplated for use with any appropriate use case.

According to a preferred embodiment of the present invention, this functionality may be implemented in the system as follows. When engaged, a list of positions into the physical book representation may be displayed as tabs on a right edge of the physical book representation. The position of the tabs may be determined as follows. The position of a tab along the height of the book (herein the Y axis) is determined in a way that is similar to displaying a list of items in a 2D application—a vertical list of items (that may have some gap between them). The position of a tab along the depth of the book (herein the Z axis) however is determined so that is coincides with that Z position of the page that contains the content the tab refers to. In other words, the tab is positioned on the page that it refers to. This gives the user a visual indication of where in the book the content for each tab is. One of ordinary skill in the art may appreciate that there are numerous ways this could be implemented, and tabs positioned, in various embodiments of the present invention, and embodiments of the present invention are contemplated for use with any such positioning and implementation means.

According to an embodiment of the present invention, although the tabs may look distinct and separate from each other because they are at different Z depths, the tabs may still connected (for example, positioned relative to each other) in the Y axis and can therefore be scrolled along that axis analogously to a 2D scrolling of a list of items.

In a preferred embodiment of the present invention, when a single tap gesture is detected on a tab, the physical book representation is modified so that it is turned to a page corresponding to the tab engaged. The turn may be done in a single step or through the use of animations. In preferred embodiments, animations are used. One of ordinary skill in the art may appreciate that there are numerous gestures that could be used to engage such an interaction, and embodiments of the present invention are contemplated for use with any such gestures.

### Selective Display of Buttons

In embodiments which allow for reading of content, it may be useful to include some buttons and other user interface elements in the 3D scene in proximity to the physical book representation. Some examples of such buttons or user interface elements include, but are not limited to, a “font” button, a “chapters” button, or any combination thereof. Such elements however may not be necessary to be displayed all the time as it may interfere with the ability of the user to focus on the content of the physical book representation. It is therefore useful to selectively display these buttons. In preferred embodiments, the system analyzes the open/shut state of the physical book representation to determine whether to display some of these user interface elements, a portion thereof, all or none of those interface elements. The elements may be displayed while the physical book representation is shut and hidden when it is open.

### Selective Display of Page Information

In embodiments which allow for reading of content, it may be useful to include in the scene some information about the page currently turned to such as which chapter the page belongs to, for example. Such elements however may interfere with the ability of the user to focus on the content of the physical book representation and so it is useful to display them only at certain times. In preferred embodiments of the present invention, the system registers the receipt of user input and displays such information for a short period of time after the input is received. The system may also be configured to ignore certain types of input, such as those that do not result in changes to the turned to page. One of ordinary skill in the art may appreciate that there are numerous ways to implement this functionality, and embodiments of the present invention are contemplated for use with any such implementations.

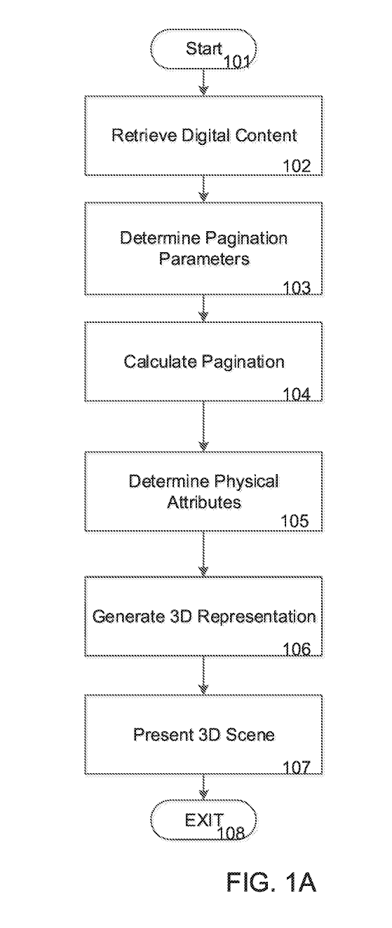

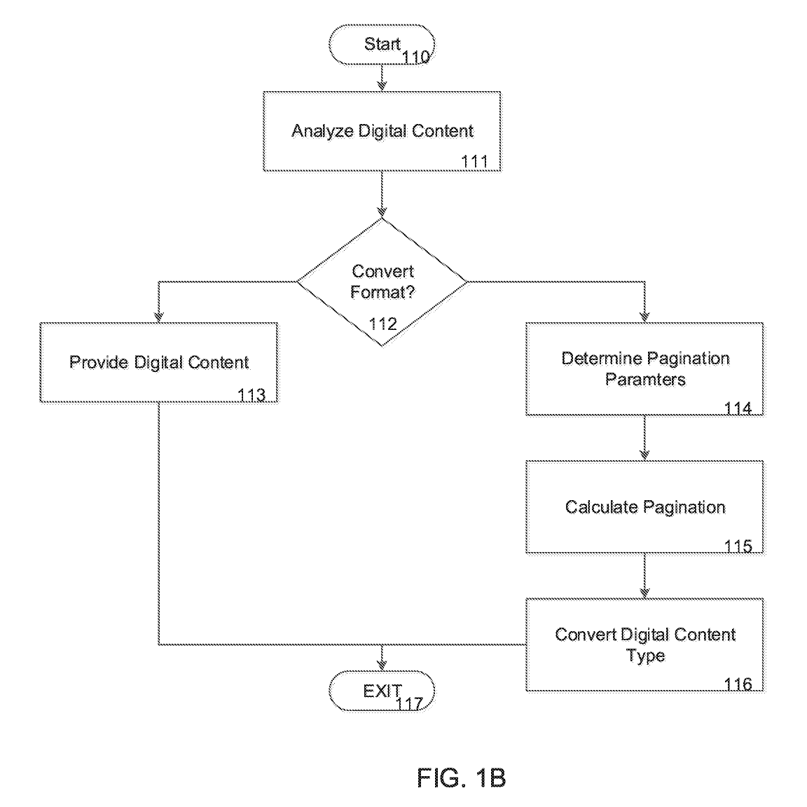

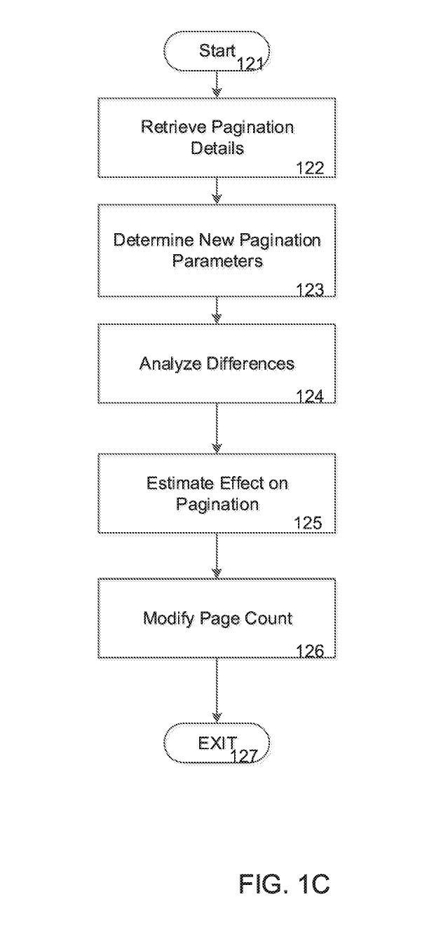

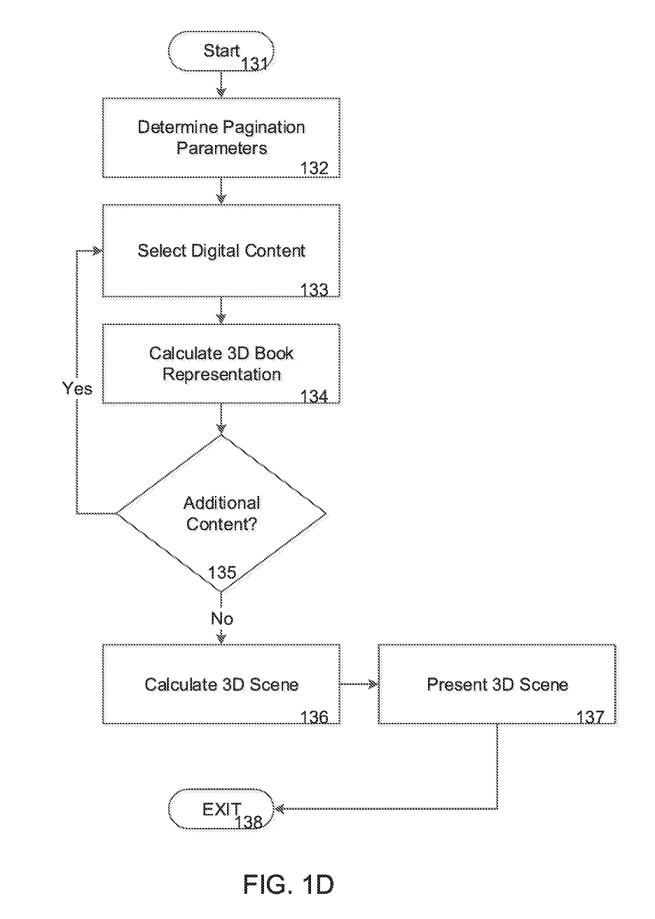

Turning now to FIG. 1A, an exemplary process flow for providing a digital content processing and viewing application implementing 3D graphical user interfaces and interactions, is shown. The process depicts the retrieval and processing of digital content for use in the 3D presentation system. The process starts at step 101, with a request for retrieval of digital content being received by the system. At step 102, the system retrieves the digital content. The digital content may be retrieved, for instance, locally, from local storage, or remotely from remote storage, such as storage on a cloud or other distributed system.

At step 103, the system determines pagination parameters that will be used in processing the digital content. In an exemplary embodiment, the pagination parameters may be stored in the system for use with digital content processed by the system. In other embodiments, the pagination parameters are stored with the digital content itself, such as data associated with the file type associated with the digital content. In other embodiments, the pagination parameters are linked to the digital content via a separate locally or remotely stored data file. One of ordinary skill in the art may appreciate that there are numerous ways to store and retrieve pagination parameters and embodiments of the present invention are contemplated for use with any type of pagination parameters.

At step 104, the system processes the metadata and determines a pagination for the digital content. As detailed previously herein, pagination parameters are used to determine and process the pagination. Exemplary methods for determining pagination are described earlier herein. One of ordinary skill in the art may appreciate that there are numerous methods for processing pagination, and embodiments of the present invention are contemplated for use with any appropriate method for determining pagination. Determining the pagination is important for preferred embodiments of the present invention, as the pagination may be used to provide information for the generation of the 3D graphical representation of the digital content. While important to preferred embodiments, there may be embodiments where pagination is not utilized, and are contemplated for use with other embodiments of the present invention.

At step 105, the system uses the processed pagination to process the physical attributes for the digital content. Physical attributes may include, but are not limited to, cover content, spine content, size of the digital content (for example, determined by page count and any other metadata related to size, such as dimensions of book in height and width proportions), page thickness, ornamental features, or any combination thereof. Detailing the physical attributes provides critical data for generation of the 3D representation of the digital content.

At step 106, the system utilizes the processed appearance features to generate the 3D representation of the digital content. Generation of the 3D representation of the digital content entails utilizing the processed appearance features to create an electronic representation that simulates a physical book when displayed on the display element of a computing device. The electronic representation mimics the physical representation, based on one or more elements, such as size of the book (for example, height, width, depth), page thickness, cover content, spine content, cover thickness, cover type (for example, paperback, hard cover), and other appearance features. In some embodiments, the system may be configured to include generation of physical wear on the eBook. For instance, where an eBook has been heavily utilized by a reader, the system can generate wear and tear lines, page creases or other graphical representations of physical characteristics one may find on a similar physical copy of a book.

At step 107, the system transmits the generated 3D scene representation data to a display element for display to the user. The generated 3D scene includes the 3D display of the physical book representation as well as any other 3D scene data, such as other physical book representation, scenery, library content, or any combination thereof. At this point, the graphical representation is provided to the user and the user may interact with the digital content through one or more interface means associated with the computing device. At this point, the process terminates (step 108).

Turning now to FIG. 1B, an exemplary process flow for processing digital content is shown. The process starts with the system being engaged to analyze and process digital content for later consumption and rendering as a 3D physical representation and the system having received digital content for processing. At step 111, the system does an initial analysis of the digital content to determine form and format of the digital content. A decision is then made by the system (decision 112) whether the digital content is in an optimal/acceptable format or whether it should be converted to a more optimal format. As detailed earlier herein, optimal formats are those that are relatively easy to process and render into a 3D physical representation.

If the content is in an optimal format, the process moves to step 113, where the digital content is provided for use in 3D graphical representation and the process may terminate at step 117.

If the content is not in an optimal format, the process moves to step 114 and the system determines the pagination parameters for use in processing the content. Pagination parameters and how to determine which pagination parameters to use is detailed earlier herein.

At step 115, the system calculates the pagination for the digital content. Calculation of the pagination for the digital content can be accomplished in various manners, as detailed elsewhere herein.

At step 116, the system converts the digital content type into a more optimal content type, such as a paged digital content format. Once converted, the system can store the converted digital content for later use in generation and presentation of a 3D scene. At this point, the process terminates at step 117.

Turning now to FIG. 1C, an exemplary process flow for accelerated page count estimation, in accordance with an embodiment of the present invention, is shown. The process starts at step 121 with the system being engaged to rapidly calculate new page count information for a digital content. At step 122, the system retrieves pagination details about the digital content from stored information.

At step 123, the system determines new pagination parameters to be used in the pagination of the digital content. Assuming there are differences in the existing pagination parameters associated with the digital content and the new pagination parameters, the system sets about determining a new page count for the digital content.

At step 124, the system identifies and analyzes the differences between the existing pagination parameters and the new pagination parameters. At step 125, the system estimates the effect on page count of the delta between the existing pagination parameters and the new pagination parameters, and at step 126, the system modifies the page count of pagination details retrieved at step 122 to derive the page count for the new pagination parameters. Advantageously, instead of recalculating and processing pagination for the entire digital content based on the new pagination parameters, the system can quickly determine the delta between the page count based on the existing and new pagination parameters, thereby saving time and resources on the process. At this point, the process terminates at step 127.

Turning now to FIG. 1D, an exemplary process for calculating and displaying a 3D scene, in accordance with an embodiment of the present invention, is shown. The process starts at step 131 with the system being engaged to present a 3D scene that includes multiple physical book representations. At step 132, the system determines pagination parameters that will be applied to digital content during the pagination process.

At step 133, the system retrieves a digital content that will be displayed in the 3D scene. As noted elsewhere herein, digital content may be retrieved from local and/or remote storage for use in the 3D scene.

At step 134, the system calculates the 3D book representation. Based at least in part on the pagination parameters, the system processes the digital content into a 3D book representation that is capable of being displayed in the 3D scene.

After processing the digital content, the system determines if there is more digital content to be processed (decision 135). If there is more digital content to be processed, the process loops back to Step 133 and continues until there is no more digital content to process.

Once there is no more digital content to process, the system proceeds to Step 136, wherein the 3D scene is calculated, based at least in part on the processed digital content. Once calculated, the system presents the 3D scene to the user at step 137. At this point, the process terminates at step 138.

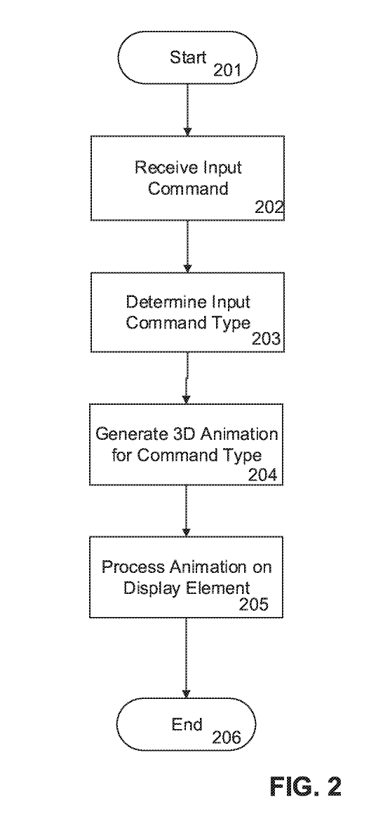

Turning now to FIG. 2, an exemplary process flow for interacting with a digital content application implementing 3d graphical user interfaces and interactions, is shown. The process depicts receiving and processing of input commands from a user on the eBook reader application. The process starts at step 201, with the system being engaged as the user inputs commands onto a computing device. At step 202, the system receives the input commands and begins processing of said commands.

At step 203, the system determines the type of input command received. In preferred embodiments, the input commands are gesture based commands, and are similar to those which one may use on a physical copy of a book. Some gestures are modified to fit the format commonly used for input devices on preferred computing devices (for example, capacitive touch or other touch screen devices). Input command types may include, for instance, but are not limited to, one finger swipe for a page turn command, two finger swipe for a chapter turn command, a pinch motion for a close book command, a reverse pinch for an open book command, a press-and-hold touch, or any combination thereof. A press-and-hold touch may be used for many different types of commands, depending on the region of the graphical representation of the eBook that is being touched. For instance, press-and-hold on an area outside of the displayed page area (for example, on the graphical representation of the unread page portion) may affect a command that brings up a series of tabs, or a chapter selection windows.

At step 204, once the command type has been determined, the system generates appropriate 3D animation data for the related command. For instance, if the input command received was a page turn, the system will generate the 3D animation content for the page turn event. Such animation details are detailed elsewhere herein.

At step 205, the system affects the display of the 3D animation content on the display element of the computing device being used. At this point, the process terminates (step 206).

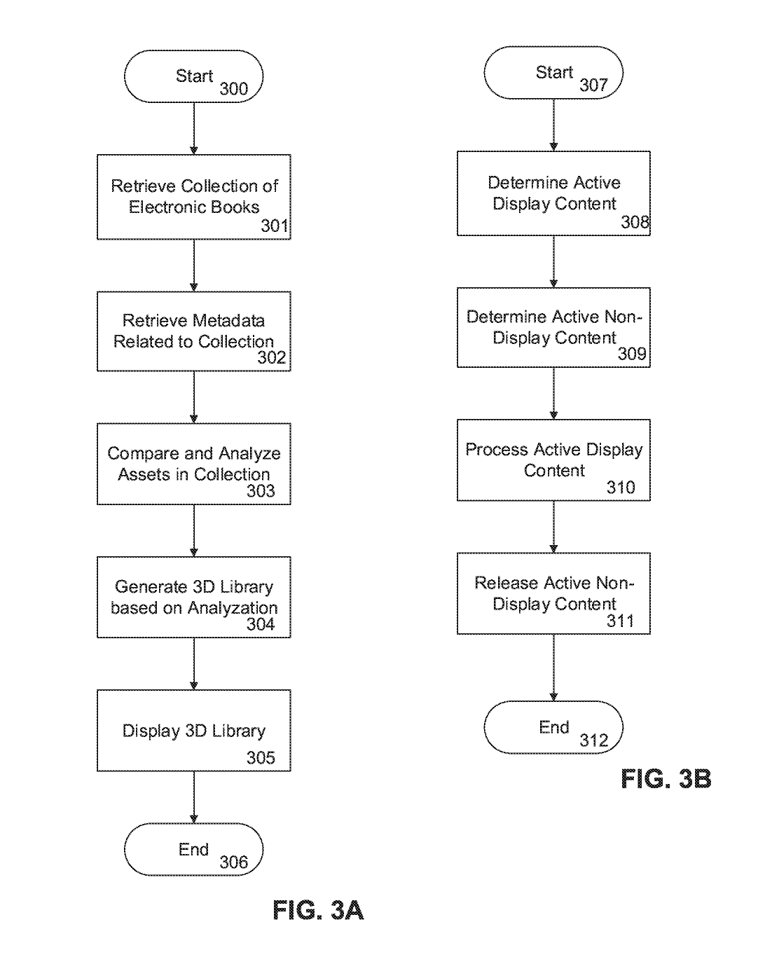

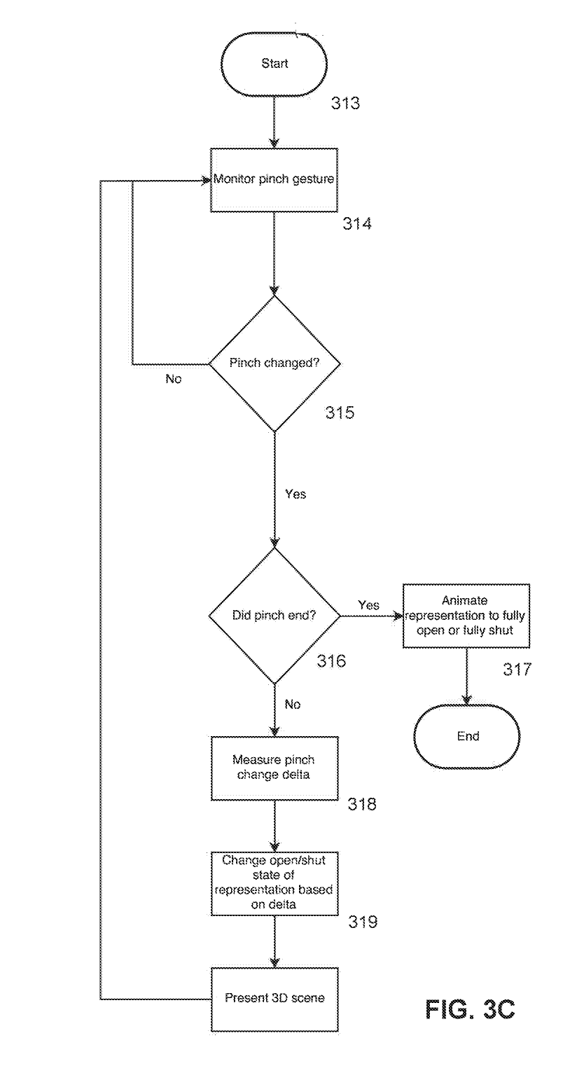

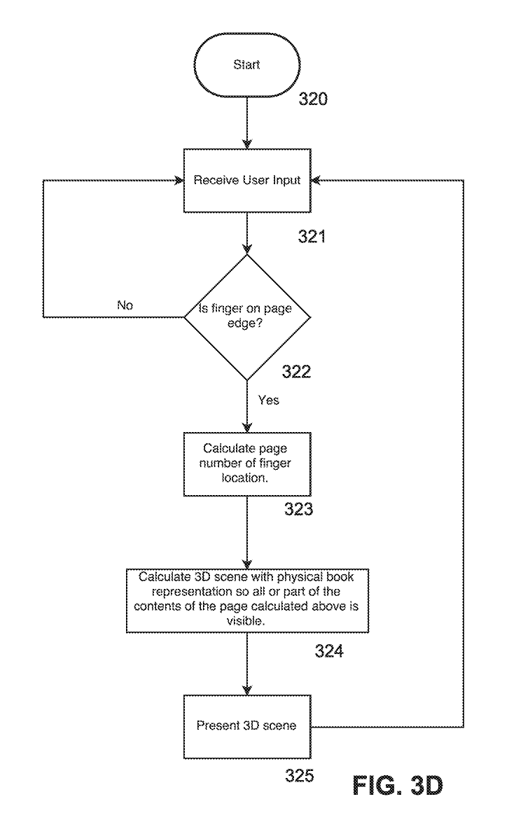

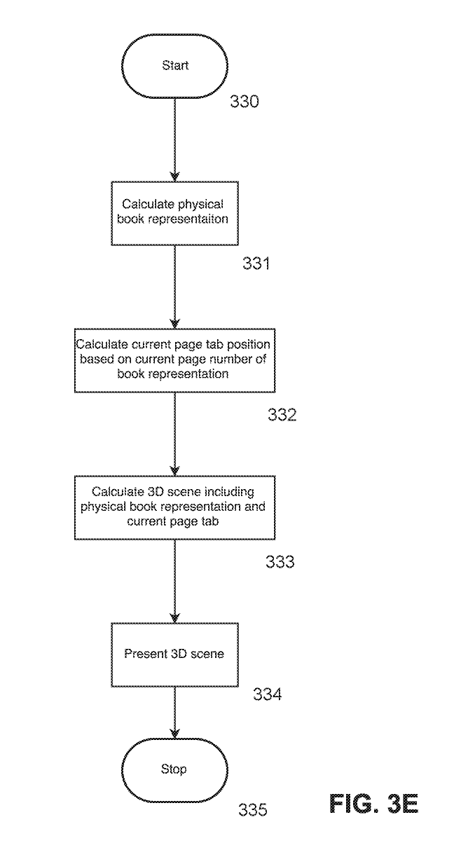

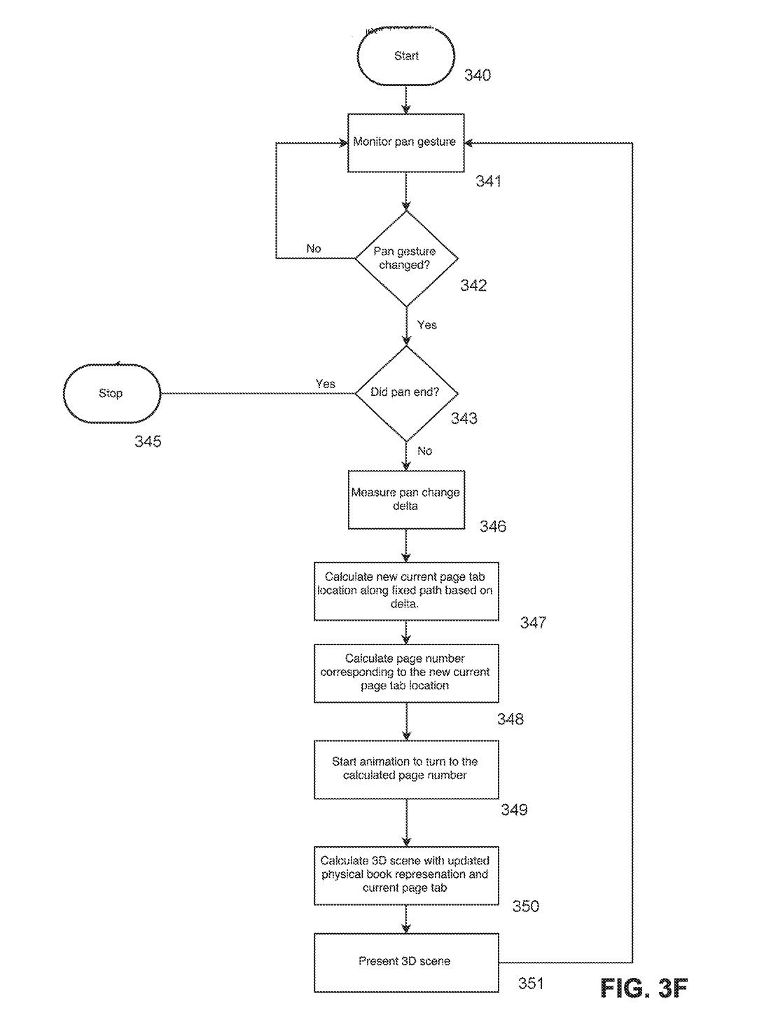

FIG. 3A illustrates an exemplary process flow for providing an eBook reader application implementing 3D graphical user interfaces and interactions. The process depicts receiving and processing of a collection of eBooks and generation of a library for display on the eBook reader application. The process starts at step 300, with the system being engaged as the user attempts to access the 3D graphical representation of a library, provided for by embodiments of the system. At step 301, the system receives the request to generate a library and retrieves a collection of one or more eBooks for display in the library.

At step 302, the system retrieves metadata associated with each eBook in the collection. As noted elsewhere herein, metadata may be stored locally or remotely, and comprises various data points that will be used in determining appearance features of each eBook to be displayed in the library.

At step 303, the system compares and analyzes the eBooks in the collection, based at least in part on the processed metadata. In a preferred embodiment of the present invention, the system will use information from the metadata, such as page count, page thickness, book dimensions, cover art, spine art, or any combination thereof, to process the appearance of each eBook to be displayed in the library. Where there are two or more books in the collection, the metadata is also used to analyze the differences between the eBooks in order to ensure the graphical representations are true to form for each eBook in relation to one another.

At step 304, the system uses the analyzed data to generate a 3D graphical representation of the eBooks in a library setting, such that the 3D graphical representation imitates the physical impression that maybe created, were the eBooks actually physical copies of the books. Once generated, the system will then transmit the 3D graphical representation data to the display element for display to the user. At this point, the process terminates at step 306.

FIG. 3B illustrates an exemplary process flow for providing an eBook reader application implementing 3d graphical user interfaces and interactions. The process depicts receiving and processing of eBook content data, to ensure minimization of resource utilization on the computing device. The process starts at step 307, with the system being engaged during utilization of the eBook reader described herein.

At step 308, the system identifies active display content being consumed by the user as presented on the display element of the computing device. Active display content may include the text or other content displayed on the display element of the computing device. This content is important as it is the data currently being consumed by the user.

At step 309, the system identifies and processes active non-display content. Active non-display content may include, for instance all or a portion of logically next to be presented content, such as the next several pages of content and/or the previous several pages of content. Having the logically next to be presented content contained in the active display content context prevents delays in load time when the user moves on to the next piece of logically next to be presented content. However, active non-display content may also include other data that has either already been consumed or is not likely to be needed in the near future (for example, during the current reading session of the user).

At step 310, the system processes the active display content to ensure presented data is accurate and current. During this step, the system may process any input events or other actions received from the user or system.

At step 311, the system identifies the portion of the active non-display content that is no longer useful or necessary. In a preferred embodiment, the system will remove all active non-display content that is not of the type that is logically next to be presented content. In certain embodiments, the system may be configured to learn and identify what content is not logically next to be presented content, such as by recording behavior of the user (for example, time on page, does user frequently flip back to already read pages, does user frequently flip to other sections, chapters or even other books). By learning more about the user's habits, the system can proactively load and unload active non-display content. Advantageously, by removing active non-display content, and preloading soon to be needed non-display content, the system simultaneously reduces resource utilization (for example, frees up memory), but also optimizes the experience for the user). At step 312, the process terminates.

Turning now to FIG. 3C, an exemplary process flow for providing an eBook reader application implementing 3d graphical user interfaces and interactions, is shown. The process depicts processing of gestures affecting the opening and closing of a physical book representation. The process starts at step 313, with the system being engaged as the user executes a pinch gesture on the physical book representation displayed on a computing device. At step 314, the system monitors the pinch gesture for changes.

The system will monitor the pinch gesture until there is a change (Decision 315). Once there is a change, the system will determine what change occurred to the pinch gesture (Decision 316). If the pinch change was not a termination of the pinch gesture, then the system will animate the physical book representation to the appropriate state (for example, open or closed) and the process will terminate at step 317.

If the pinch gesture did end, the system will measure the change in the delta of the pinch gesture (step 318). Once calculated, the system will change the state of the physical book representation (for example, open or closed) based on the delta (Step 319). Once changed, the system will present the updated 3D scene to the user and revert to step 314.

Turning now to FIG. 3D, an exemplary process flow for providing an eBook reader application implementing 3d graphical user interfaces and interactions, is shown. The process depicts peeking into a page of a physical book representation. The process starts at step 320, with the system being engaged in relation to a peeking into page event. At step 321, the system receives related user input. The system will determine if the user input is on a page edge (determination 322), which is a preferred placement of input to effect a peek into page event. If the input is not on the edge, the process will revert to step 321 and wait for additional input.

If the user input is on the page edge, the system will move to step 323 and calculate the page number proximate the finger location on the page edge, based on the characteristics of the physical book representation. Once the page is determined, the system will then calculate the 3D scene associated with that page in the physical book representation so that all, or part of the contents of the page, are visible (step 324). Once processed, the system will present the 3D scene to the user (Step 325).

Turning now to FIG. 3E, an exemplary process flow for providing an eBook reader application implementing 3d graphical user interfaces and interactions, is shown. The process depicts current page tab positioning of a physical book representation. The process starts at step 330, with the system being engaged in relation to a current page tab positioning event. At step 331, the system calculates a physical book representation for a particular digital content. At 332, the system will calculate a current page tab position based on the current page number the user is at in the physical book representation of the digital content.

At step 333, the system generates a 3D scene based on the physical book representation and the current page tab. Once calculated, the system presents the 3D scene to the user (Step 334). At which point, the process terminates at step 335.

Turning now to FIG. 3F, an exemplary process flow for providing an eBook reader application implementing 3d graphical user interfaces and interactions, is shown. The process depicts user interaction with a current page tab. The process starts at step 340, with the system being engaged in relation to a pan gesture being received. At step 341, the system monitors the pan gesture for changes. The system determines at step 342 whether there has been a change in the gesture. If no change occurs, the system returns to step 341 and waits for a change in the gesture.

If there is a change, the system determines if the change is the end of the pan gesture (determination 343). If the pan gesture ends (step 344), the system terminates at step 345. Otherwise, the system processes the change in the delta of the pan gesture, measuring the change for use in determining alterations to the 3D scene.

At step 346, the system calculates a new current page tab location based on the change in the pan gesture, generally along a fixed path. At step 347, the system calculated the page number associated with the new current page tab location.

At step 348, the system generates and processes an animation for the physical book representation related to the changing of pages from the current page to the updated page.

At step 349, the system calculates the 3D scene associated with the updated physical book representation and current page tab. At this point, the system presents the 3D scene to the user and the process terminates or loops back through.

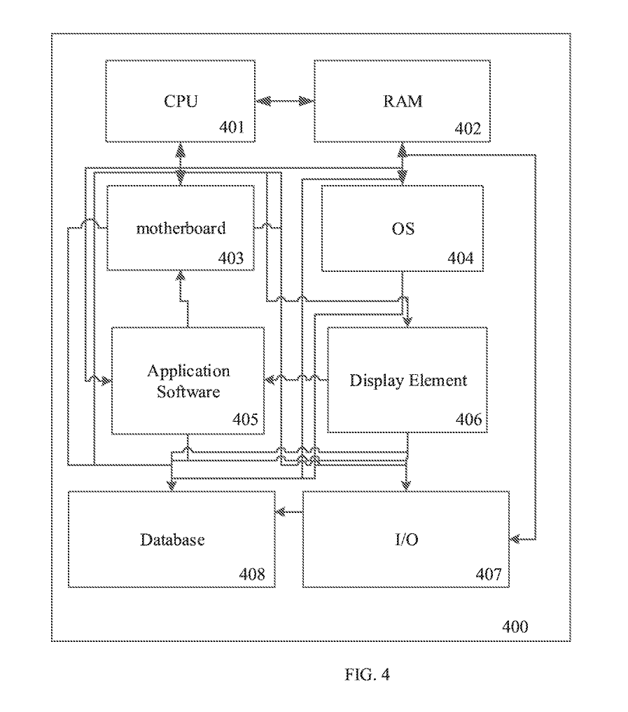

Turning now to FIG. 4, a schematic overview of a computing device, in accordance with an embodiment of the present invention, is shown. As shown in FIG. 4, one of ordinary skill in the art may appreciate that a computing device 400 appropriate for use with embodiments of the present application may generally be comprised of one or more of a Central processing Unit (CPU) 401, Random Access Memory (RAM) 402, a storage medium (for example, hard disk drive, solid state drive, flash memory, cloud storage) 403, an operating system (OS) 404, one or more application software 405, one or more display elements 406, one or more input/output devices/means 407 and one or more databases 408. Examples of computing devices usable with embodiments of the present invention include, but are not limited to, personal computers, smartphones, laptops, mobile computing devices and tablet PCs. Certain computing devices configured for use with the system do not need all the components described in FIG. 4. The term computing device may also describe two or more computing devices communicatively linked in a manner as to distribute and share one or more resources, such as clustered computing devices and server banks/farms. One of ordinary skill in the art may understand that any number of computing devices could be used, and embodiments of the present invention are contemplated for use with any computing device.

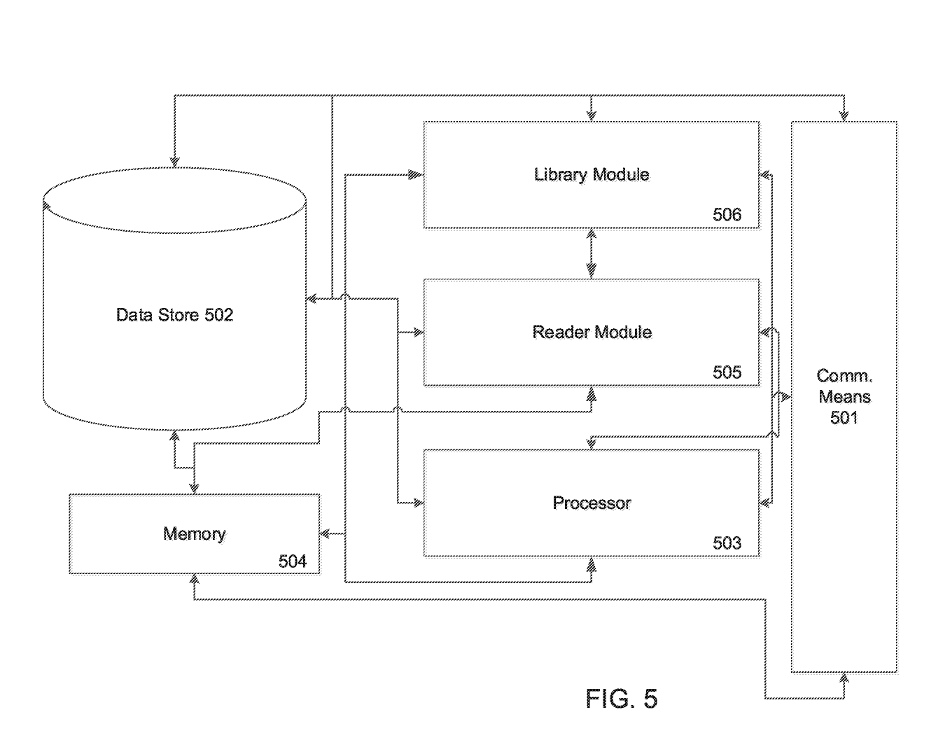

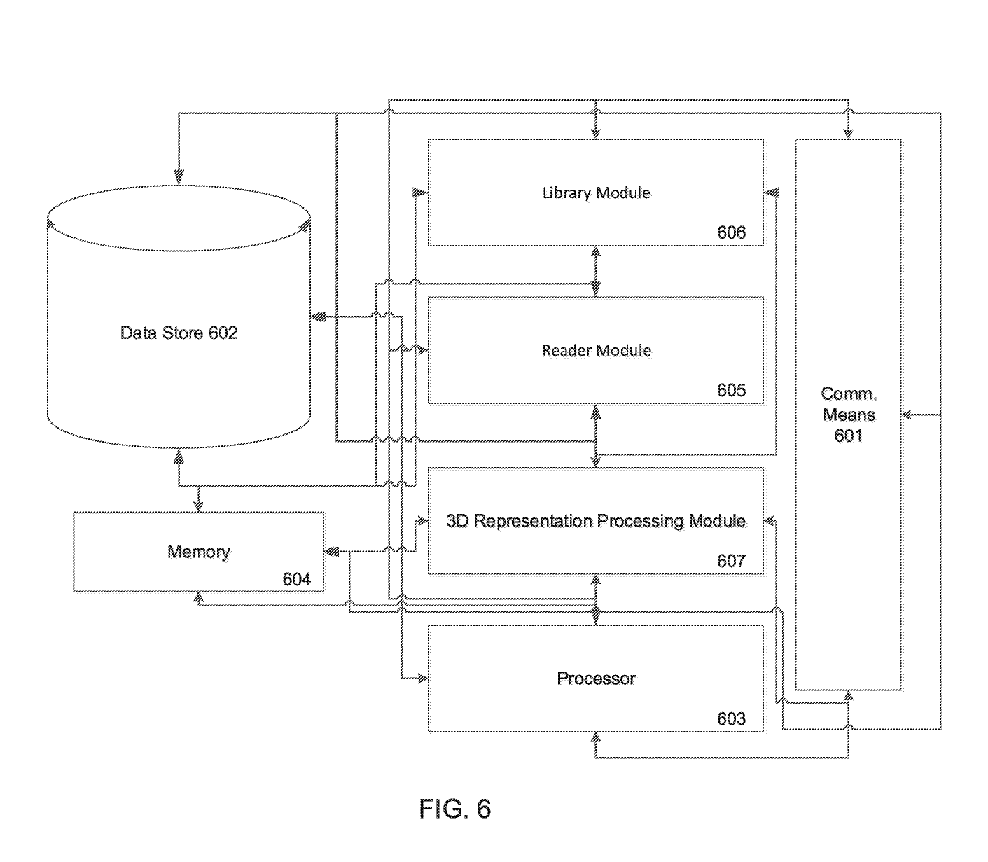

Turning to FIG. 5, according to an embodiment of the present invention, a system for an eBook reader application implementing 3D graphical user interfaces and interactions is comprised of one or more communications means 501, one or more data stores 502, a processor 503, memory 504, a library module 505 and a reader module 506. FIG. 6 shows an alternative embodiment of the present invention, comprised of one or more communications means 601, one or more data stores 602, a processor 603, memory 604, a library module 605, a reader module 606 and a 3D representation processing module 607. The various modules described herein provide functionality to the system, but the features described and functionality provided may be distributed in any number of modules, depending on various implementation strategies. One of ordinary skill in the art may appreciate that the system may be operable with any number of modules, depending on implementation, and embodiments of the present invention are contemplated for use with any such division or combination of modules as required by any particular implementation. In alternate embodiments, the system may have additional or fewer components. One of ordinary skill in the art may appreciate that the system may be operable with a number of optional components, and embodiments of the present invention are contemplated for use with any such optional component.

According to an embodiment of the present invention, the library module is configured to provide the feature sets identified and detailed previously herein related to the generation, display and processing of the library representation. This may include, but is not limited to, storing and monitoring collections of eBooks for presentation and display in the 3D graphical representation of the library in the application.

According to an embodiment of the present invention, the reader module is configured to provide the feature sets identified and detailed previously herein related to the generation, display and processing of the reader portion of the application. For instance, this may include, but is not limited to, the generation and display of individual eBooks and interactions with the displayed eBook as input commands are received from the user.

According to an embodiment of the present invention, the 3D representation processing module may be configured to provide the processing and implementation of the creation of 3D graphical representations of various aspects of the invention, such as the library and individual book appearances, as well as the animations and effects associated with the embodiments of the present invention. In certain embodiments, the 3D representation processing module may also assist with dictating workflow between processing units present on a computing device (for example, graphics processing unit, central processing unit).

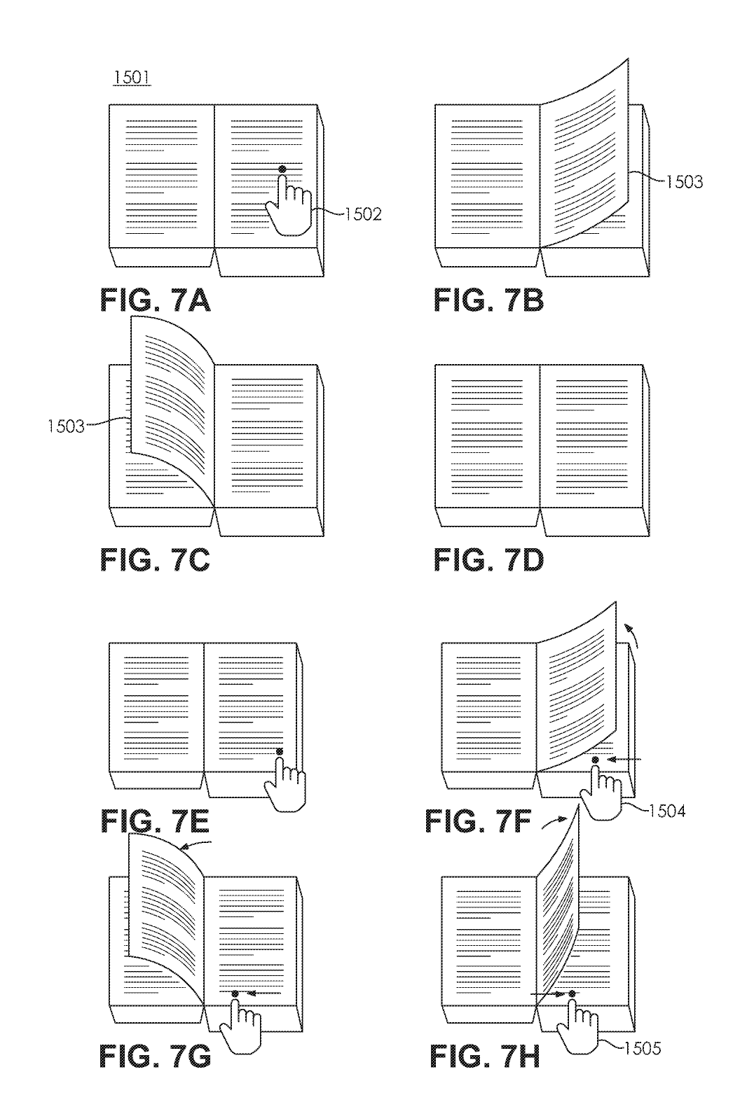

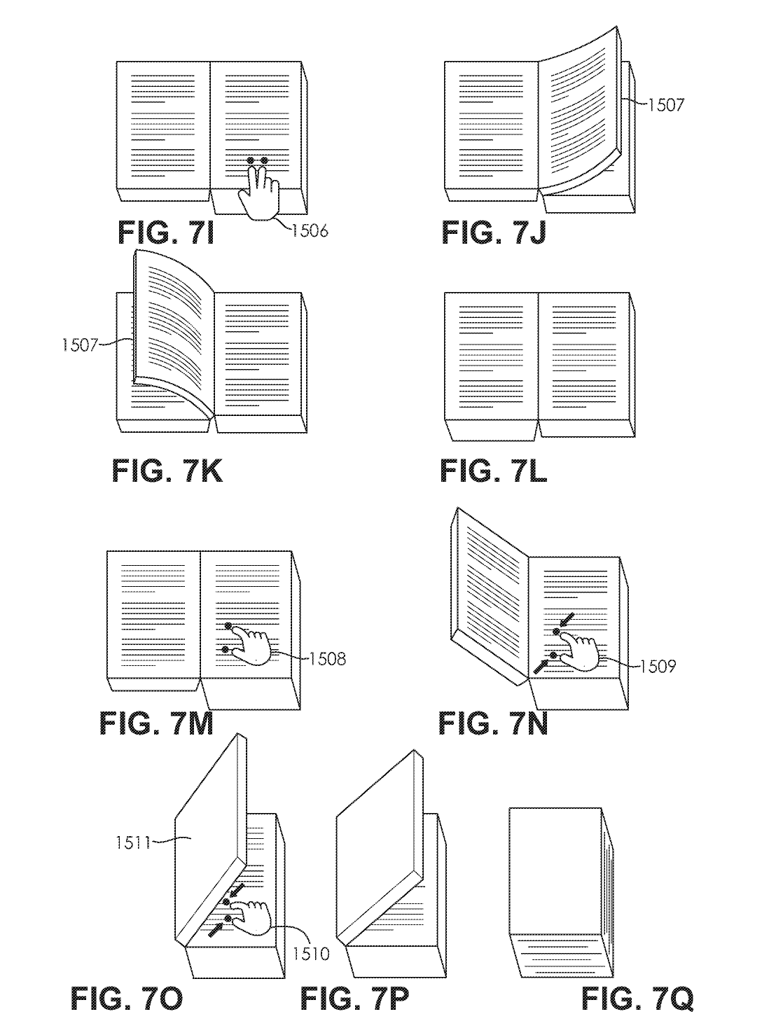

Turning now to FIGS. 7A-12, various exemplary graphical representations are shown. FIG. 7A-7Q are illustrations of a interaction with a physical book representation, in accordance with an embodiment of the present invention. In FIG. 7A, a physical book representation 1501 is shown in an open state, with a single touch operation 1502 being presented upon a page of the physical book representation. FIG. 7B shows the beginning of a page turn event 1503 on a physical book representation, and FIG. 7C shows the continuation of that page turn event. FIG. 7D shows the physical book representation with the page turn event completed and the new pages being displayed.

Turning now to FIGS. 7E-7H a manual page turn is shown. FIG. 7E shows a touch interaction being started. FIG. 7F shows the touch having moved left (1504) and the page turned by an amount proportional to the distance moved by the touch. FIG. 7G shows the touch moved even further left and the page turn correspondingly progressing by a proportional amount. FIG. 7H shows the touch moved back right (1505) and the page turn corresponding turning back by a proportional amount.

FIGS. 7I-7L are illustrations of interactions with a physical book representation resulting from a two finger touch event. In this depiction, FIG. 7I shows a two finger touch event 1506 being received on a physical book representation in an open state. The two finger touch event 1506, in this case, affects a chapter turn event 1507, as depicted in FIGS. 7J-L.

Turing to FIGS. 7M-7Q, a pinch event is show, as well as the effects caused on a physical book representation. In FIG. 7M, a two finger touch 1508 is received on the physical book representation. FIG. 7N shows the change in the initial two finger touch 1508 to an inward pinch event 1509 via the closing proximity of the fingers (delta between two fingers decreasing). The physical book representation is also changed from the fully open state in FIG. 7M to a partially closed state where the amount it is closed is proportional to the pinch delta. FIG. 7O shows the delta between the two fingers further reducing and the physical book representation further closing proportionally. FIG. 7P shows the fingers removed from the screen at which point an animation begins that continues to close the book. FIG. 7Q shows the book after the animation is completed with the book in the fully closed position.

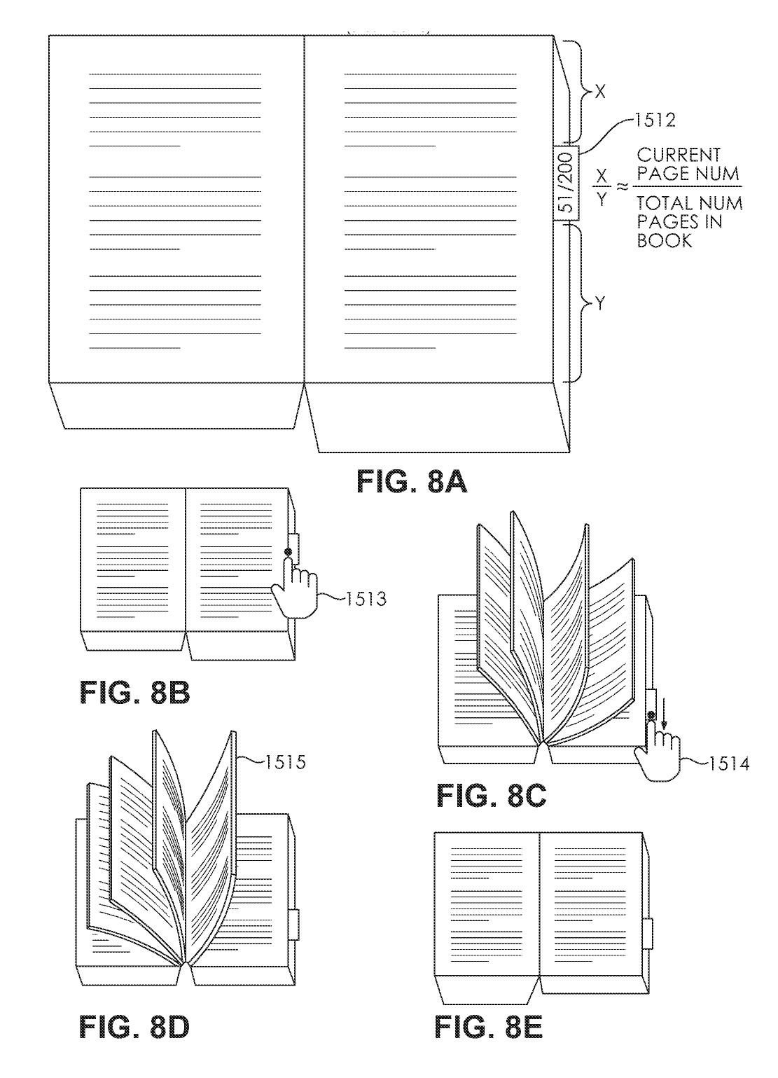

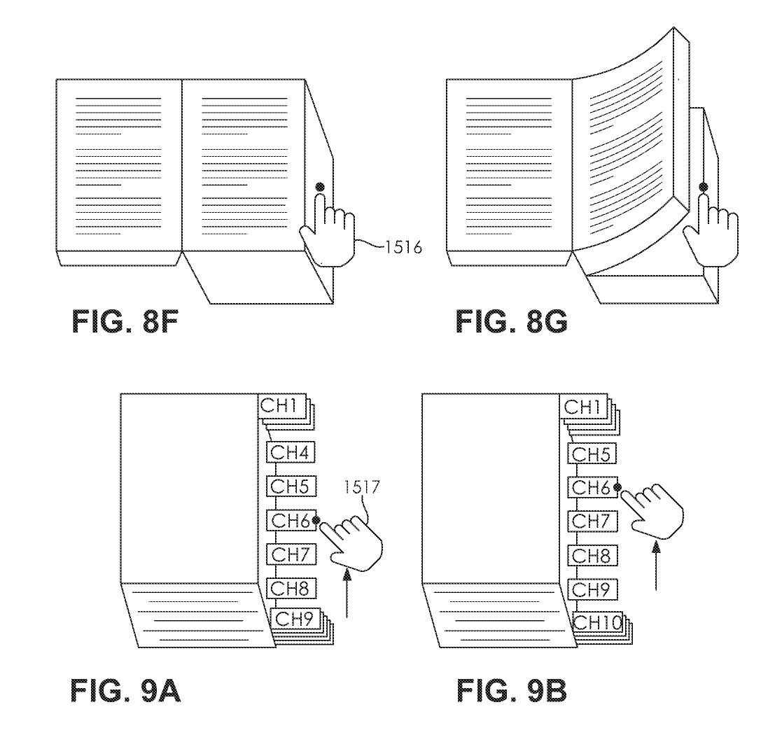

Turning now to FIGS. 8A-8G, illustrations of interactions with the current page tab and edges of a physical book representation, in accordance with an embodiment of the present invention, are shown. FIG. 8A shows a physical book representation with a current page tab 1512. In this embodiment, the current page tab shows the current page the reader is at, as well as the total number of pages in the digital content. The formula shown is a representative formula that may be used to determine where the current page tab is located on the edge of the physical book representation, based on current page number and total page number.

FIGS. 8B-8E show a touch interaction 1813 on the current page tab. Moving along a vertical line, the change in touch interaction (shown in FIG. 8C) effects the change in pages. For instance, the further down along the vertical axis the touch interaction goes, the higher the page number in the physical book representation will be changed to upon completion. FIG. 8C shows the page turn animation in effect and FIG. 8D shows the physical book representation at the page turned to after the animation is completed.

FIGS. 8F-8G show a touch interaction 1816 on an edge of the physical book representation. FIG. 8F shows the touch interaction 1816 occurring on the edge of the physical book representation. FIG. 8G shows a “peek into a page” type preview of the page proximate to the touch interaction 1816. Collectively, when used in this manner, the reader may jump to a page (or peek into a page) located at the approximate location of the touch interaction 1816.

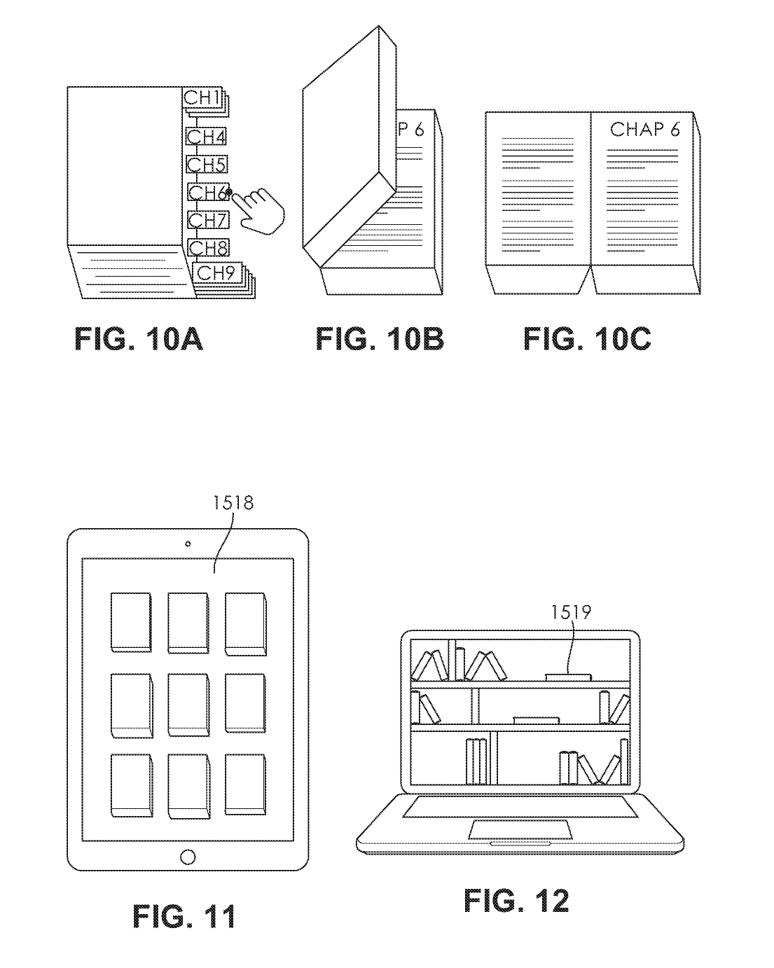

Turning now to FIGS. 9A-10C, a user interaction on the navigation tabs of a physical book representation is shown. In these figures, the tabs correspond to chapters of the book. FIGS. 9A-9B show a user interaction for scrolling the navigation tabs. In FIG. 9A, a touch 1517 is received on a navigation tab. FIG. 9B shows the touch as having moved vertically and the navigation tabs having scrolled up in the direction of the touch movement.

FIGS. 10A-10C show a user interaction for opening the book to page using the navigation tabs. FIG. 10A shows a tap touch event on a navigation tab referring to chapter 6. This causes an animation to be generated which turns the book to chapter 6. FIG. 10B shows the physical book representation while the said animation is in progress and displays the book in the partially opened state. FIG. 10C shows the physical book representation after said animation is complete and the book is fully opened to chapter 6.

Turning to FIGS. 11 and 12, illustrations of a graphical user interface showing a collection display 1518, in accordance with an embodiment of the present invention, is shown. In these FIGs, multiple digital content items are shown in a “library”, ready for interaction by readers. The embodiment shown in FIG. 11, has the digital content items laid out neatly on the interface in organized matrix format. In FIG. 12, the digital content items are shown as if they were on bookshelves, with a spine 1519 of the physical book representations being prominently displayed. In both FIGS. 11 and 12, the thickness of each book is readily apparent.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art may appreciate that there are numerous manners in which the system could be configured and embodiments of the present invention are contemplated for use with any configuration.

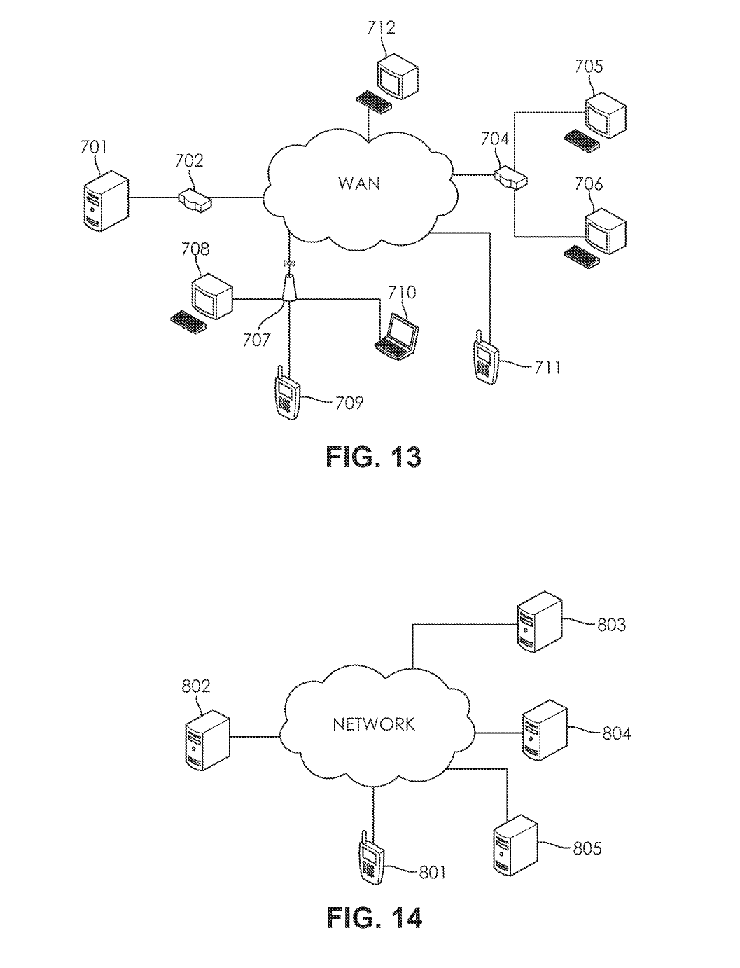

Referring to FIG. 13, a schematic overview of a cloud based system that interacts with the eBook reader application in accordance with an embodiment of the present invention is shown. The cloud based system is comprised of one or more application servers 703 for electronically storing information used by the system. Applications in the application server 203 may retrieve and manipulate information in storage devices and exchange information through a Network 701 (e.g., the Internet, a LAN, WiFi, Bluetooth, etc.). Applications in server 703 may also be used to manipulate information stored remotely and process and analyze data stored remotely across a Network 701 (e.g., the Internet, a LAN, WiFi, Bluetooth, etc.).

According to an exemplary embodiment, as shown in FIG. 13, exchange of information through the Network 701 may occur through one or more high speed connections. In some cases, high speed connections may be over-the-air (OTA), passed through networked systems, directly connected to one or more Networks 701 or directed through one or more routers 702. Router(s) 702 are completely optional and other embodiments in accordance with the present invention may or may not utilize one or more routers 702. One of ordinary skill in the art may appreciate that there are numerous ways server 703 may connect to Network 701 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 703 via Network 701 or other network in numerous ways. For instance, a component may connect to the system i) through a computing device 712 directly connected to the Network 701, ii) through a computing device 705, 706 connected to the WAN 701 through a routing device 704, iii) through a computing device 708, 709, 710 connected to a wireless access point 707 or iv) through a computing device 711 via a wireless connection (e.g., CDMA, GMS, 3G, 4G) to the Network 701. One of ordinary skill in the art may appreciate that there are numerous ways that a component may connect to server 703 via Network 701, and embodiments of the present invention are contemplated for use with any method for connecting to server 703 via Network 701. Furthermore, server 703 could be comprised of a personal computing device, such as a smartphone, acting as a host for other computing devices to connect to.

Turning now to FIG. 14, a continued schematic overview of a cloud based system in accordance with an embodiment of the present invention is shown. In FIG. 8, the cloud based system is shown as it may interact with users and other third party networks or APIs. For instance, a user of a mobile device 801 may be able to connect to application server 802. Application server 802 may be able to enhance or otherwise provide additional services to the user by requesting and receiving information from one or more of an external content provider API/website or other third party system 803, a constituent data service 804, one or more additional eBook data services 805 or any combination thereof. Additionally, application server 802 may be able to enhance or otherwise provide additional services to an external content provider API/website or other third party system 803, a constituent data service 804, one or more additional eBook data services 805 by providing information to those entities that is stored on a database that is connected to the application server 802. One of ordinary skill in the art may appreciate how accessing one or more third-party systems could augment the ability of the system described herein, and embodiments of the present invention are contemplated for use with any third-party system.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, Python, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

The functions, systems and methods herein described could be utilized and presented in a multitude of languages. Individual systems may be presented in one or more languages and the language may be changed with ease at any point in the process or methods described above. One of ordinary skill in the art may appreciate that there are numerous languages the system could be provided in, and embodiments of the present invention are contemplated for use with any language.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system providing a reader application implementing 3D graphical user interfaces and interactions, said system comprising:
a computer processor;
a non-volatile computer-readable memory; and
a graphical display element,
wherein the non-volatile computer-readable memory is communicatively connected to said processor and graphical display element and is configured with computer instructions configured to:
retrieve digital content from a data store;
select pagination parameters;
generate pagination for said digital content, based at least in part on said pagination parameters;
select physical attributes;
generate a 3D physical book representation of said digital content, based at least in part on said pagination and said physical attributes, wherein said 3D physical book representation of said digital content comprises a 3D scene of at least a portion of said digital content such that said 3D scene mimics the appearance of a physical book; and
display said 3D physical book representation to said graphical display element.

2. The system of claim 1, wherein the non-volatile computer-readable memory is further configured to:
convert said pagination to a second digital content item,
wherein said digital second digital content item comprises a different format from said digital content retrieved from said data store,
wherein said format of said second digital content item provides more efficient processing than a format of said digital content retrieved from said data store; and
wherein said generation of said 3D physical book representation utilizes said second digital content item.

3. The system of claim 1, wherein the non-volatile computer-readable memory is further configured with computer instructions configured to:
select second pagination parameters;
analyze difference between pagination parameters and second pagination parameters;
calculate estimated effect on page count based on said difference between pagination parameters and second pagination parameters; and
generate modified page count based at least in part on said calculated estimated effect on page count for second pagination parameters.

4. The system of claim 1, wherein the non-volatile computer-readable memory is further configured with computer instructions configured to:
calculate a plurality of 3D physical book representations, based at least in part on said pagination parameters;
generate a second 3D scene, wherein said second 3D scene contains said plurality of 3D physical book representations; and
display said second 3D scene on said display element.

5. The system of claim 1, wherein the non-volatile computer-readable memory is further configured with computer instructions configured to:
receive user input;
identify predefined gesture type from said user input;
identify location of said user input;
determine a group of pages of said physical book representation to turn based on said predefined gesture type and location; and
generate a page turn animation based at least in part on said group of pages of said physical book representation.

6. The system of claim 1, wherein the non-volatile computer-readable memory is further configured with computer instructions configured to:
receive user input;
identify predefined gesture type from said user input;
identify location of said user input;
track changes in said user input;
analyze said changes in said user input; and
alter physical book representation, based on said changes in user input, such that a number of pages in said user input are turned proportional to said changes in said physical book representation.

7. The system of claim 1, wherein the non-volatile computer-readable memory is further configured with computer instructions configured to:
calculate a current page tab location based at least in part on said pagination and a current page position of said physical book representation; and
add a current page tab to said physical book representation at a point on said physical book representation relative to said current page tab location.

8. The system of claim 1, wherein the non-volatile computer-readable memory is further configured with computer instructions configured to:
receive user input;
identify predefined gesture type from said user input;
identify location of said user input, wherein said location is associated with a current page tab present on said physical book representation;
track changes in said user input;
analyze said changes in said user input;
update location of said current page tab in said physical book representation based at least in part on said changes in said user input;
determine page number for said updated location of said current page tab; and
generate a page turn animation, based at least in part on said updated location of said current page tab.

9. The system of claim 1, wherein the non-volatile computer-readable memory is further configured with computer instructions configured to:
receive user input;
identify predefined gesture type from said user input;
generate animation to open or close book based on said user input and a current state of said physical book representation.

10. The system of claim 1, wherein the non-volatile computer-readable memory is further configured with computer instructions configured to:
receive user input;
identify predefined gesture type from said user input;
track continuously changes in the user input;
generate animation to proportionally alter an open or close book state based on said tracked user input.

11. The system of claim 1, wherein the non-volatile computer-readable memory is further configured with computer instructions configured to:
receive user input;
identify predefined gesture type from said user input;
determine a page number of a page in said physical book representation associated with said user input; and
generate animation and rendering of said page such that at least a portion of content on said page is visible for display on said display element.

12. A method for providing a reader application implementing 3d graphical user interfaces and interactions, said method comprising the steps of:
retrieving written material from a data store;
retrieving metadata from said written material;
determining page size for a page of said written material, based at least in part on said metadata;
processing metadata associated with said written material to determine one or more appearance features;
generating a 3D representation of said written material, wherein said 3D representation of said written material comprises at least 3D exterior imagery of said written material such that said 3D exterior imagery mimics the appearance of a physical book; and
displaying said 3D representation of said written material on a graphical display element.

13. The method of claim 12, further comprising the steps of:
converting said pagination to a second digital content item,
wherein said digital second digital content item comprises a different format from said digital content retrieved from said data store,
wherein said format of said second digital content item provides more efficient processing than a format of said digital content retrieved from said data store; and
wherein said generation of said 3D physical book representation utilizes said second digital content item.

14. The method of claim 12, further comprising the steps of:
selecting second pagination parameters;
analyzing a difference between pagination parameters and second pagination parameters;
calculating estimated effect on page count based on said difference between pagination parameters and second pagination parameters; and
generating modified page count based at least in part on said calculated estimated effect on page count for second pagination parameters.

15. The method of claim 10, further comprising the steps of:
calculating a plurality of 3D physical book representations, based at least in part on said pagination parameters;
generating a second 3D scene, wherein said second 3D scene contains said plurality of 3D physical book representations; and
displaying said second 3D scene on said graphical display element.

16. The method of claim 12, further comprising the steps of:
receiving user input;
identifying predefined gesture type from said user input;
identifying location of said user input;
determining a group of pages of said physical book representation to turn based on said predefined gesture type and location; and
generating a page turn animation based at least in part on said group of pages of said physical book representation.

17. The method of claim 12, further comprising the steps of:
receiving user input;
identifying predefined gesture type from said user input;
identifying location of said user input;
tracking changes in said user input;
analyzing said changes in said user input; and
altering the physical book representation, based on said changes in user input, such that a number of pages proportional to said changes in said user input are turned in said physical book representation.

18. The method of claim 12, further comprising the steps of:
calculating a current page tab location based at least in part on said pagination and a current page position of said physical book representation; and
adding a current page tab to said physical book representation at a point on said physical book representation relative to said current page tab location.

19. The method of claim 12, further comprising the steps of:
receiving user input;
identifying predefined gesture type from said user input;
identifying location of said user input, wherein said location is associated with a current page tab present on said physical book representation;
tracking changes in said user input;
analyzing said changes in said user input;
updating location of said current page tab in said physical book representation based at least in part on said changes in said user input;
determining page number for said updated location of said current page tab; and
generating a page turn animation, based at least in part on said updated location of said current page tab.

20. The method of claim 12, further comprising the steps of:
receiving user input;
identifying a predefined gesture type from said user input;
generating animation to open or close book based on said user input and a current state of said physical book representation.

21. The method of claim 12, further comprising the steps of:
receiving user input;
identifying a predefined gesture type from said user input;
tracking continuously changes in the user input;
generating animation to proportionally alter an open or close book state based on said tracked user input.

22. The method of claim 12, further comprising the steps of:
receiving user input;
identifying predefined gesture type from said user input;
determining a page number of a page in said physical book representation associated with said user input; and
generating animation and rendering of said page such that at least a portion of content on said page is visible for display on said graphical display element.
